(19) United States
(12) Patent Application Publication
(10) Pub. No.: US 2013/0269785 A1
(43) Pub. Date: Oct. 17, 2013

(54) INDIRECT-INJECTION METHOD FOR MANAGING THE SUPPLY OF CRYOGENIC LIQUID TO A TRUCK FOR TRANSPORTING HEAT-SENSITIVE PRODUCTS

(71) Applicants: Celso Zerbinatti, Buc (FR); Dominique Jouvaud, Paris (FR); Geraldine Rames-Langlade, Viroflay (FR)

(72) Inventors: Celso Zerbinatti, Buc (FR); Dominique Jouvaud, Paris (FR); Geraldine Rames-Langlade, Viroflay (FR)

(73) Assignee: L'Air Liquide Societe Anonyme Pour L'Etude Et L'Exploitation Des Procedes Georges Claude, Paris (FR)

(21) Appl. No.: 13/994,227

(22) PCT Filed: Oct. 19, 2011
(86) PCT No.: PCT/FR2011/052444

§ 371 Date: Jun. 14, 2013

(30) Foreign Application Priority Data
Dec. 16, 2010 (FR) 1060612

(51) Int. Cl. F17D 3/00

(52) U.S. Cl. CPC F17D 3/00
USPC 137/1; 137/613

(57) ABSTRACT

The invention relates to a method for managing the supply of cryogenic liquid to a truck for transporting heat-sensitive materials, said truck implementing a method using said cryogenic liquid to transfer negative calories to the materials. Said method is a so-called indirect-injection method in which the liquid is fed into a heat-exchanger system located inside the truck, where said liquid evaporates. The transfer of cold to the materials is achieved by means of an exchange between the atmosphere surrounding the materials and the cold walls of the heat-exchanger system, characterized in that the heat-exchanger system is supplied with cryogenic liquid by implementing the following measures: an upstream two-position valve, generally closed, is placed upstream from the heat-exchanger system; a proportional analog valve, generally open, is placed downstream from the heat-exchanger system; and a downstream two-position valve, generally open, is placed downstream from the analog valve.

The present invention relates to the field of the refrigerated transport of heat-sensitive products, such as pharmaceutical products and food products, in refrigerated trucks.

It is known that refrigerated transport is an essential link of the cold chain, and the reliability of this link is based on the cooling quality that the cold-producing system onboard the truck can offer during all the steps occurring in this link, from the loading of the products to the delivery thereof at the final destination.

By way of illustration, it is therefore essential that the refrigerating equipment of the trucks can maintain, in one or some of the insulated chambers of the truck, a suitable temperature, typically between −10° C. and −25° C. for deep-frozen products, and typically between 0° C. and 12° C. for fresh products, during all of the steps that occur.

The cold-producing units that are most widespread today in truck refrigerated transport are refrigerating units, the operation of which is based on vapor compression cycle technology. These refrigerating units use a refrigerant which, via a compression/expansion cycle, generates frigories which are sent into the chamber by fans. A heat engine using fuel enables the energy to be provided which is necessary for starting the compressor of the system. These cold-producing units which are very widely used nevertheless have the following disadvantages:

1) the presence of moving parts lead to frequent breakdowns; this reduces the profitability of the system

2) they generate considerable noise disturbance

3) they use fossil fuel and therefore produce large amounts of CO₂.

However, new techniques that are more environmentally friendly have appeared on the market; these are processes using cryogenic liquids as a coolant source. Therefore, companies sell the so-called “direct injection” process (also known as CTD in this industry) wherein a cryogenic liquid like liquid nitrogen is sprayed directly into the chamber(s) to be cooled. This simple process, however, produces a risk of anoxia for the driver when loading or unloading the chambers since the nitrogen is injected directly into the chambers and consequently reduces the oxygen concentration of the atmosphere. Safety management then requires complex physical and logical barriers, which can, however, turn out to be not very reliable.

Other parties in this field propose another so-called “indirect injection” process (also known as CTI in this industry) which uses in the truck (in the product storage space) one or more heat exchangers, wherein a cryogenic fluid like liquid nitrogen circulates, the enclosure being furthermore provided with an air circulating system (fans) bringing this air into contact with the cold walls of the exchanger, which therefore allows the air inside the product storage space to be cooled.

The liquid nitrogen inserted into the exchangers therefore releases frigories while changing to the gaseous state, then escapes outside the truck. In this process, the liquid nitrogen is therefore never injected directly into the chambers; the chamber remains filled with air during the entire operation, and the risk of anoxia is therefore considerably reduced or even theoretically non-existent (subject to leaks).

However, the use of this process, although being safer than the previous process, is more complex to implement and can generally require higher nitrogen consumption to achieve equivalent technical performance.

Currently, in the existing indirect injection processes, the admission of the quantity of nitrogen necessary to reduce the temperature of the chamber and maintain this temperature over time is managed by so-called “all or nothing” valves, i.e. which are either 100% open, or 100% closed, both at the inlet to the truck (to be more precise, upstream of the cold chamber for storing the products, the all or nothing valve is located outside this chamber, outside the truck) and at the truck gas outlet (downstream of the cold chamber for storing the products). The consumption of nitrogen of the process is therefore directly linked to the flow of nitrogen that can pass into the exchangers and into the supply circuit (capacity which is therefore not an adjustable parameter) and to the opening duration of the valves.

Yet it was seen above that the CTI process is a complex process, the effectiveness of which is dependent on the heat exchanges organized with the ambient air inside the enclosure. The use of all or nothing valves does not help to allow the optimization of the phenomena.

One of the aims of the present invention is therefore to propose a new management of the supply of cryogen of such an indirect injection process, for particularly optimizing the quantity of cryogen (for example of liquid nitrogen) necessary for reducing the temperature of the air inside the chambers below a required set-point, and for maintaining these conditions during the various required steps of the transportation.

As will be seen in greater detail below, the present invention proposes the use, at the circuit outlet (downstream of the exchanger(s)), of an analog valve, which is normally open, which allows the opening, closing and control of the quantity of fluid supplying the exchangers (proportional valve, solenoid valve, or mass flow controller (MFC) even if the MFCs are costly devices, etc).

However, firstly described in detail below is the current operation of such refrigerated transportation using indirect injection (CTI), and particularly the operation of the all or nothing valves which currently are present at the entry into the circuit (upstream of the exchangers) and at the outlet of the circuit (downstream of the exchangers), such as to better understand the disadvantages.

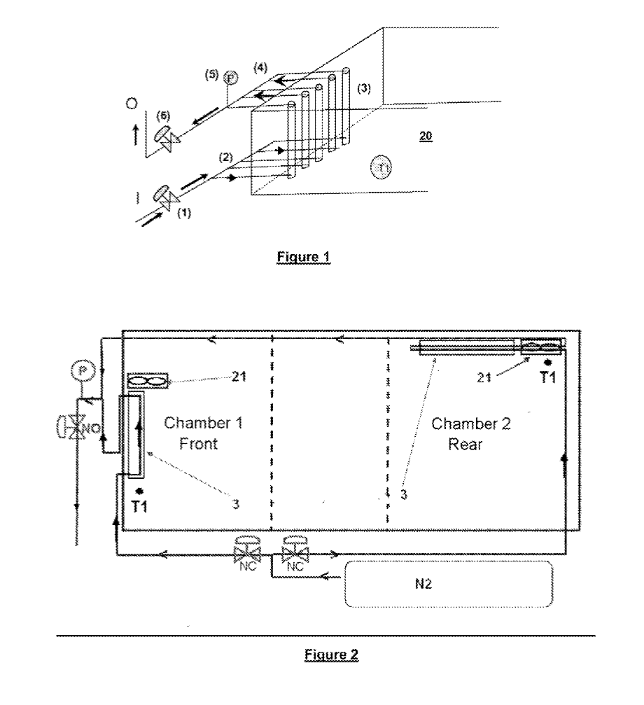

The following description will be given with reference to FIG. 1 appended hereafter, which is a partial schematic diagram of such CTI equipment in accordance with current practice (prior art).

As mentioned above, the control of the quantity of cryogen, for example liquid nitrogen, supplying such a CTI process (chamber 20 inside the truck, which chamber is provided with exchangers 3) currently takes place using at least two all or nothing valves 1 and 6, one at the inlet and one at the outlet, the process then including at least the following elements, seen in the following order:
a tank of liquid nitrogen (not shown in FIG. 1),
an all or nothing valve 1 at the inlet, which is normally closed, which allows the supply of cryogen, for example nitrogen, to the circuit,
a means of distributing the liquid nitrogen (for example a manifold means, “2” in the figure),
evaporators 3 (or heat exchangers) inside the truck,
a manifold 4 for collecting the nitrogen gas exiting the exchangers,
a pressure sensor 5,
an all or nothing valve 6 at the outlet, which is normally open,
given-diameter piping which links these elements.

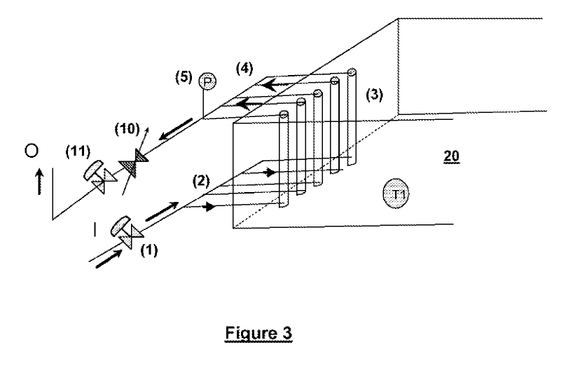

Also located in the chamber 20 are:
fanning systems (not shown in the figure for reasons of clarity but they will be shown better within the context of appended FIG. 2) which are positioned at the exchangers, the flows of which are controlled, for intensifying the heat exchanges between the ambient air of the chamber and the exchangers (by sucking the air through the exchangers and forcing it into contact with the exchangers) and homogenizing the temperature of the air inside the chamber.

A temperature detector (T1) manages the opening and closing of the on-off inlet valve 1; it is located for example at the inlet of the route of the air into the exchangers and measures the temperature of the air of the chamber before the cooling thereof within the exchangers.

For each additional chamber, a new supply circuit is added which includes, for example, an all or nothing valve at the inlet, which is normally closed, heat exchangers, an outlet all or nothing valve which is normally open, etc (an example of a two-chamber scenario and of positioning of the temperature detectors is illustrated in appended FIG. 2).

Refrigeration in the prior on-off mode typically takes place in two steps:

1. At start-up or after opening a door, a mode of rapid reduction in temperature is adopted.

2. Once the set-point temperature is reached (detector T1 in the chamber) a control mode is adopted for maintaining the temperature of the chamber at the value of the set-point.

The operation of the CTI process in this on-off mode is typically as follows: when the measured temperature T1 is greater than the set-point temperature, the inlet valve 1 opens (the outlet valve 6 being already open by default), therefore allowing the supply of cryogen to the exchangers. The liquid nitrogen transforming into gas releases frigories which are absorbed by the air in contact with these exchangers. The fans recover this cooled air in order to circulate it in the chamber. The nitrogen gas is then ejected outside the chamber into the surrounding atmosphere. When the measured temperature T1 reaches the set-point temperature, the inlet valve 1 closes, thus stopping the supply of cryogen to the exchangers and therefore the cooling of the air inside the chamber. The reduction in the temperature of the chamber and the maintaining thereof are obtained by cycles of opening and closing the valve 1. The frequency and the duration of opening the valve 1 will be greater during the rapid reduction step than during the control step. When the valve 1 opens, irrespective of the considered step, the flow of cryogen inserted into the heat exchangers will be dependent solely on the nitrogen pressure of the tank and the pressure drops of the various components of the equipment. Therefore, this flow of cryogen is linked to the design of the system and is, for a given piece of equipment, identical upon each valve opening irrespective of the process step.

In other words, since the flow of nitrogen cannot be adjusted, the quantity of nitrogen is not optimized, and this leads to an excessive consumption of nitrogen.

This interrupted flow of nitrogen and the reaction time for opening and closing the valve also lead to a large range in the temperature of the air of the chamber, which is not satisfactory.

Furthermore, when the inlet valve 1 is closed, the nitrogen which is upstream of this valve heats up and leads to an increase in the pressure of the tank. When the inlet valve opens again, some of the nitrogen will be used to cool down the nitrogen supply piping, which reduces the thermal efficiency of the evaporators.

Moreover, the high pressure of the nitrogen in the tank will cause, at each cycle of opening and closing the valve, a large fluctuation in the pressure of the nitrogen inside the piping.

This fluctuation has a major disadvantage in terms of safety and more particularly in terms of detecting nitrogen leaks in the chamber. As already mentioned, in this CTI process, the nitrogen is not injected into the chambers but is carried in piping running from the source of liquid nitrogen to the evaporators and from the evaporators to the outflow to the outside; since the evaporators and some of this piping are located inside the chambers, the risk of anoxia is then linked solely to the occurrence of a leak of nitrogen in the chamber coming, for example, from either a total fracture, or from a partial fracture of this piping, or even from a leaking connection or welding.

The occurrence of a leak is currently detected by the drop in the pressure (measured for example using the pressure sensor 5 placed downstream of the exchangers) which automatically brings the process to a stop by closing the inlet valve 1. However, since the pressure of the nitrogen gas fluctuates due to the use of an on-off inlet valve, and to prevent the system from stopping unexpectedly, in an untimely or unjustified manner, the detection of the leak by a drop in the pressure is only commonly achieved from a certain reduction in the pressure. It is seen therefore that the use of all or nothing valves involves a variation in the pressure such that only leaks of a certain flow can be detected; the leaks of a lower flow cannot be detected while they can also cause a reduction in the oxygen content in the chamber and lead to a risk of anoxia. In the on-off-mode CTI process, the detection of leaks is therefore not very effective, responsive or accurate.

One of the aims of the present invention is then to propose a new management of the supply of cryogen of such an indirect injection process, for particularly offering a solution to the disadvantages of the prior art which are described above, and particularly to allow detection of the gas leaks which takes place as soon as the lowest levels of leaks occur.

The invention then relates to a method for managing the supply of cryogenic liquid to a truck for transporting heat-sensitive products, said truck implementing a process using said cryogenic liquid to transfer frigories to the products, said process being a so-called indirect injection process in which the liquid is sent into a heat-exchanger system located inside the truck, where it evaporates, the transfer of cold to the products being achieved by means of an exchange between the atmosphere surrounding the products and the cold walls of the heat-exchanger system, characterized in that the exchanger system is supplied with cryogenic liquid by implementing the following measures:
an upstream all or nothing valve, which is normally closed, is placed upstream of the exchanger system;
a proportional analog valve, which is normally open, is placed downstream of the exchanger system;
and a downstream all or nothing valve, which is normally open, is placed downstream of the analog valve.

Other features and advantages of the present invention will become clearer in the following description, which is given by way of illustration but is in no way limiting, with reference to the appended drawings wherein:

FIG. 1 is a partial schematic diagram of CTI equipment in accordance with the current practice (prior art).

FIG. 2 is a schematic diagram of the box inside a transportation truck according to the prior art, comprising in this case two chambers for storing products, and for particularly illustrating more clearly the operation of the exchangers and the position of the temperature detectors T1.

FIG. 3 is a partial schematic diagram of CTI equipment in accordance with the present invention.

The mode of FIG. 1 has already been described in detail above, in order to explain the operation and the disadvantages of the current operating modes of CTI based on all or nothing valves at the inlet and outlet, and this will not therefore be discussed here again.

FIG. 2 allows clearer illustration of the detail of an example of a box inside a transportation truck (side view), comprising in this case two chambers for storing products (for example a chamber for fresh products and another chamber for frozen products), and for particularly illustrating more clearly the operation of the exchangers and the position of the temperature detectors T1 for the mode given by way of example here.

For each chamber, an all or nothing valve at the inlet, which is normally closed (“NC”), is placed upstream, each chamber is provided with heat exchangers (vertical for the chamber 1, and horizontal at the top of the case for the chamber 2), where the cryogen coming from the tank located under the truck is circulated, the gas flows obtained at the outlet of each chamber being sent to collection piping, provided in this case with an outlet single all or nothing valve which is normally open (“NO”).

Furthermore, an embodiment is shown clearly here wherein a temperature detector (T1) is placed in each chamber, which detector manages the opening and closing of each on-off inlet valve; it is located:
for the chamber 1 at the inlet of the route of the air into the exchangers (the fans 21 being located on the other side of the exchangers and sucking, towards them, the air through the exchangers), the detector therefore measuring the temperature of the air of the chamber prior to the cooling thereof within the exchangers;
for the chamber 2 in this case again at the inlet of the route of the air into the considered exchangers, i.e. substantially at the fans 21 which in this case push the air inside the exchangers.

Identified in FIG. 3, which illustrates a partial view of an embodiment in accordance with the invention, are the following elements, seen in the following order:
a liquid nitrogen tank (not shown in FIG. 3),
an all or nothing valve 1 at the inlet, which is normally closed, which allows the supply of cryogen, for example of nitrogen, to the exchanger system 3 (made up for this embodiment of a plurality of parallel vertical exchangers, though this is only one of the numerous exchanger configurations commonly used in this industry);
a means of distributing the liquid nitrogen (for example a manifold means, “2” in the figure),
the evaporators 3 (or heat exchangers) inside the truck,
a manifold 4 for collecting the nitrogen gas exiting the exchangers,
a pressure sensor 5,
a proportional analog valve 10, which is normally open, which allows the opening, closing and control of the supply of the exchangers 3,
an all or nothing valve 11 at the outlet (downstream of the proportional valve), which is normally open,
piping of a given diameter, which connects these elements.

No details will be given again here for the fanning systems positioned at the exchangers or the presence of the temperature detector (T1) which can measure the temperature of the air inside the chamber for storing the products.

According to one of the embodiments of the present invention, the management of the supply of cryogen to the exchangers comprises in this case two steps:

1. a mode of rapid reduction in temperature, typically at start-up or after opening a door,

2. a control mode: once the set-point temperature is reached (detector T1 in the chamber), this is a mode for maintaining the temperature of the chamber at the value of the set-point.

The management of the supply is based on the opening percentage for the proportional valve 10, as a function of the temperature of the air of the chamber (T1) and of the desired set-point temperature (set-pointT).

During the step of rapid reduction in temperature, the measured temperature (T1) is clearly greater than the set-point (set-pointT), and the proportional valve 10 is then ordered to open (opening percentage close to 100%), the evaporators are then supplied with nitrogen with a maximum flow and release frigories which are absorbed by the air of the chamber. Then as T1 approaches set-pointT, the proportional valve is ordered to close, gradually, therefore controlling the quantity of liquid nitrogen inserted into the evaporators and therefore the quantity of frigories.

Then, in the control step, when T1 has reached the set-pointT, the percentage of the proportional valve is adjusted in order to maintain T1 at the desired value.

Without having to provide further details, data acquisition and processing means (for example an automaton, etc.) are used in this case in order to acquire all of the necessary data (and particularly the data for pressure, for temperature inside the chamber, etc.) and to take retrospective action by giving orders to the system, particularly for closing one valve or another, or to vary the opening rate for the valve 10.

Therefore, the quantity of liquid nitrogen inserted into the evaporators is controlled as a function of the temperature inside the chamber which allows the consumption of nitrogen of the CTI process to be optimized.

This optimized control mode is still simple to implement, quite inexpensive, and quite small-scale (therefore easy to incorporate into existing equipment) while guaranteeing the thermal performance required to guarantee the cold chain.

The control presented here furthermore has the following advantages:
it allows smaller leaks to be detected and therefore a better level of safety to be provided;
it allows the flexibility of the process to be increased and more particularly that of the rapid reduction step.

The reasons for such advantages are described in detail as follows:
Indeed, since the operation of this control is based on the opening percentage for the valve 10, the flow of nitrogen in the supply circuit for the evaporators is almost continuous, and consequently, the pressure in the circuit is much more stable (compared to what was indicated above in the description of the prior art). Therefore, the detection of a leak through a drop in pressure (as explained above) can occur for a drop in pressure that is much smaller than in the on-off control mode of the prior art, which means that smaller flow leaks can be detected. This mode of control using a proportional valve therefore allows a much wider range of leak flows to be covered than in the previous on-off control mode.
Moreover, during the rapid reduction step, by varying the opening percentage for the proportional valve, the duration of this rapid reduction step can be controlled: by way of illustration, after opening a door, the proportional valve 10 can be completely opened, allowing an extremely rapid reduction in temperature, while the use of an opening percentage for the valve that is high but less than 100% will allow the set-point temperature to be reached in a time that is certainly longer but with optimized nitrogen consumption, for, in summary, adapting to all user situations.

The leak tests for equipment such as that of FIG. 3 use the two all or nothing valves 1 and 11, according to detection procedures that are moreover conventional for a person skilled in the art, wherein the equipment portion between the two all or nothing valves is pressurized, and wherein the possible pressure drop that occurs is observed, according to protocols that can vary, as directed by the brain (automaton) governing the equipment process control, for example (purely by way of illustration):
the confinement of a certain pressure P between the two all or nothing valves at the time t₀, and the measurement (sensor 5) of the pressure P′ at the time t₀+Δt;
the use, for given equipment, of two protocols:
   the confinement of a certain pressure P between the two all or nothing valves at the time t₀, and the measurement (sensor 5) of the pressure P′ at the time t₀+Δt, wherein Δt=1 minute, the test being carried out automatically every 10 minutes;
   the confinement of a certain pressure P between the two all or nothing valves at the time t₀, and the measurement (sensor 5) of the pressure P′ at the time t₀+Δt, wherein Δt=10 minutes, the test being carried out automatically every 24 hours;
      etc . . . numerous other possible protocols could be cited.

The invention recommends therefore the use, downstream of the exchanger system, of a proportional analog valve, which is normally open.

As will be clear to a person skilled in the art, instead of using this proportional valve 10, a “smart” all or nothing valve can also be considered, i.e. which is for example provided with either PID control, or a calibrated hole. However, these extremely simple and quite inexpensive solutions are not as effective as a proportional valve. Indeed, PID control on an all or nothing valve will allow the frequency for opening and closing the valve to be optimized but the delivered cryogen flow will remain the same for each opening, and it cannot be varied.

The calibrated hole will allow the delivered cryogen flow to be limited, but still it will not allow it to be varied, and will not allow any optimization.

1-2. (canceled)

3. A method for managing the supply of cryogenic liquid to a truck for transporting heat-sensitive products, said truck implementing a process using said cryogenic liquid to transfer frigories to the products, said process being a so-called indirect injection process in which the liquid is sent into a heat-exchanger system located inside the truck, where it evaporates, the transfer of cold to the products being achieved by means of an exchange between the atmosphere surrounding the products and the cold walls of the heat-exchanger system, characterized in that the exchanger system is supplied with cryogenic liquid by implementing the following measures:
an upstream all or nothing valve, which is normally closed, is placed upstream of the exchanger system;
a proportional analog valve, which is normally open, is placed downstream of the exchanger system;
and a downstream all or nothing valve, which is normally open, is placed downstream of the analog valve.

4. Equipment for supplying cryogenic liquid to a truck for transporting heat-sensitive products, said truck implementing a process using said cryogenic liquid to transfer frigories to the products, said process being a so-called indirect injection process in which the liquid is sent into a heat-exchanger system located inside the truck, where it evaporates, the transfer of cold to the products being achieved by means of an exchange between the atmosphere surrounding the products and the cold walls of the heat-exchanger system, characterized in that it includes:
an upstream all or nothing valve, which is normally closed, placed upstream of the exchanger system,
a proportional analog valve, which is normally open, placed downstream of the exchanger system,
and a downstream all or nothing valve, which is normally open, placed downstream of the analog valve.
